(19) United States
(12) Patent Application Publication
(10) Pub. No.: US 2023/0351149 A1
(43) Pub. Date: Nov. 2, 2023

(54) CONTRASTIVE CAPTIONING NEURAL NETWORKS

(71) Applicant: Google LLC, Mountain View, CA (US)

(72) Inventors: Jiahui Yu, Jersey City, NJ (US); Zirui Wang, San Francisco, CA (US); Vijay Vasudevan, Los Altos Hills, CA (US); Ho Man Yeung, Mountain View, CA (US); Seyed Mojtaba Seyedhosseini Tarzjani, Foster City, CA (US); Yonghui Wu, Fremont, CA (US)

(21) Appl. No.: 18/141,340

(22) Filed: Apr. 28, 2023

Related U.S. Application Data
(60) Provisional application No. 63/336,274, filed on Apr. 28, 2022.
(60) Provisional application No. 63/337,991, filed on May 3, 2022.

(51) Int. Cl. G06N 3/04

(52) U.S. Cl. CPC G06N 3/04

(57) ABSTRACT

Methods, systems, and apparatus, including computer programs encoded on computer storage media, for processing multi-modal inputs using contrastive captioning neural networks.

### CROSS-REFERENCE TO RELATED APPLICATIONS

This application claims priority to U.S. Provisional Application No. 63/336,274, filed on Apr. 28, 2022, and U.S. Provisional Application No. 63/337,991, filed on May 3, 2022. The disclosures of the prior applications are considered part of and are incorporated by reference in the disclosure of this application.

### BACKGROUND

This specification relates to processing inputs using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs on one or more computers that processes multi-modal inputs that include both a visual input, i.e., an image or multiple video frames from a video, and text using a contrastive captioning neural network. As will be described below, the neural network is referred to as a “contrastive captioning” neural network because the neural network can be pre-trained jointly using both a contrastive learning loss and a captioning loss.

Particular embodiments of the subject matter described in this specification can be implemented so as to realize one or more of the following advantages.

This specification describes a contrastive captioning (CoCa) neural network that has an architecture that allows the neural network to be pre-trained jointly with a contrastive objective and a captioning loss. Unlike standard encoder-decoder transformers where all decoder layers attend to encoder outputs, CoCa omits cross-attention in the first set of decoder layers so that the first set of decoder layers encode unimodal textual representations. In other words, CoCa has a decoder (language model neural network) with multiple initial self-attention layers without any cross-attention layers. CoCa then cascades the remaining decoder layers that cross-attend to the visual encoder to generate multimodal image-text representations. Thus, CoCa effectively decouples a language model neural network into a unimodal text decoder followed by a multimodal text decoder.

A contrastive loss is applied between unimodal visual and textual embeddings, together with a captioning loss on the multimodal decoder outputs forecasting text tokens.

By sharing the same computational graph, i.e., sharing the same neural network architecture, the two training objectives are computed efficiently with minimal computational overhead. That is, the quantities required to compute both losses are obtained through a single forward pass through the CoCa network.

This allows the neural network to be pretrained from scratch in a single stage on a unified form of image-text pairs, e.g., including one or more of web-scale alt-text data or annotated images, seamlessly unifying natural language supervision for representation learning.

In other words, for each training pair, the system applies both the contrastive objective between outputs of the visual encoder and unimodal text decoder, and the captioning objective at the output of the multimodal decoder.

Furthermore, CoCa can be trained on both image annotation data and noisy image-text data by treating all labels simply as text. The generative loss on image annotation text therefore provides a fine-grained training signal similar to a single-encoder cross-entropy loss approach, effectively subsuming all three pretraining paradigms into a single unified method.

Moreover, as a result of the decoupled decoder (language model) design of CoCa, both training losses can be considered efficiently. Since unidirectional language models are trained with causal masking on complete sentences, the decoder can efficiently generate outputs for both contrastive and generative losses with a single forward propagation (compared to two passes for a bidirectional approach).

Therefore, the majority of the compute is shared between the two losses and CoCa only induces minimal overhead compared to standard encoder-decoder models. On the other hand, while many existing methods train model components with multiple stages on various data sources and/or modalities, CoCa is pretrained end-to-end from scratch directly with various data sources (e.g., using both annotated images and noisy alt-text images) by treating all labels as texts for both contrastive and generative objectives.

Thus, the described techniques achieve improved pre-training efficiency, i.e., can achieve equivalent or better performance than conventional techniques using fewer FLOPs and fewer training iterations.

Pre-training large multi-modal models that can be used for real-world tasks generally results in significant carbon dioxide (CO₂) emissions and a significant amount of electricity usage, e.g., because the data sets on which the pre-training is done are extremely large and the models have significant numbers of parameters. By decreasing the number of FLOPs required to be performed and performing fewer training iterations for the reasons described above, the described techniques significantly reduce the CO₂ footprint of the pre-training process while also significantly reducing the amount of electricity consumed by the pre-training process.

Additionally, this pre-training scheme allows the neural network to achieve state-of-the-art performance on a broad range of downstream tasks through either zero-shot transfer or minimal task-specific adaptation. Specific examples of downstream tasks will be described in more detail below.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 is a flow diagram of an example process for training the contrastive captioning neural network.

FIG. 3 shows the training of the contrastive captioning neural network.

FIG. 4 shows the adaptation of the contrastive captioning neural network to various downstream tasks.

Like reference numbers and designations in the various drawings indicate like elements.

### DETAILED DESCRIPTION

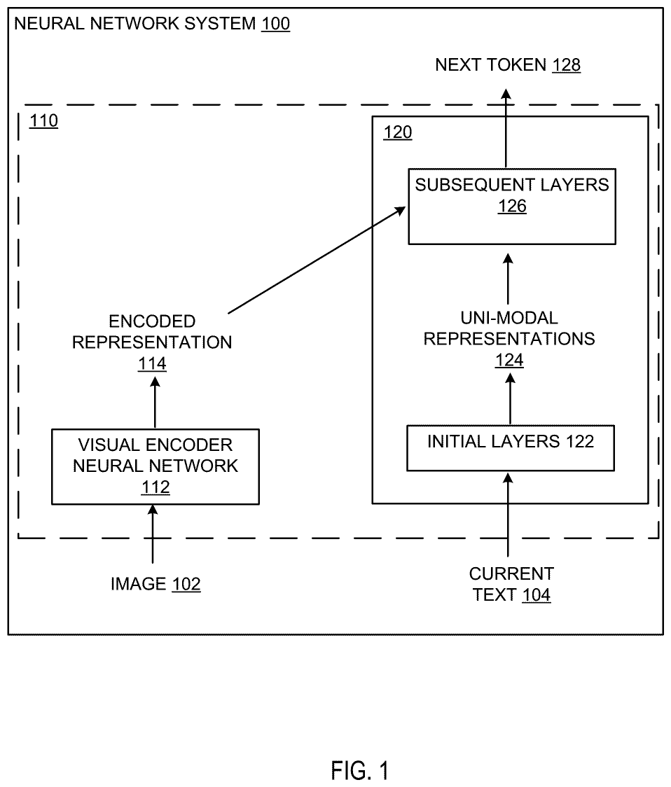

FIG. 1 shows an example neural network system 100. The neural network system 100 is an example of a system implemented as computer programs on one or more computers in one or more locations, in which the systems, components, and techniques described below can be implemented.

The system 100 is a system that processes multi-modal inputs that include both a visual input 102, i.e., an image or multiple video frames from a video, and text using a contrastive captioning neural network 110.

As will be described below, the neural network 110 is referred to as a “contrastive captioning” neural network because the neural network 110 can be pre-trained jointly using both a contrastive learning loss and a captioning loss.

The contrastive captioning neural network 110 includes (i) a visual encoder neural network 112 that is configured to process a visual input 102 that includes one or more images to generate an encoded representation 114 of the visual input 102 and (ii) a language model neural network 120 that includes a set of initial uni-modal neural network layers 122 and a set of subsequent neural network layers 126 that include both cross-modal layers and uni-modal layers.

That is, when processing a multi-modal input that includes both a visual input 102 and a text sequence, the representation generated by the initial layers 122 within the language model neural network 120 is a uni-modal representation 124 that depends only on the text sequence while the representation generated by the subsequent layers 126 is a multi-modal representation that depends on both the representation 124 of the text sequence generated by the initial layers 122 and the visual input 102.

Generally, the language model neural network 120 is configured to process a current text sequence 104 to generate an output defining a new token 128 to be appended to the current text sequence 104.

The output defining a new token 128 to be appended to the current text sequence 104 generally includes a respective score for each token in a vocabulary of tokens. The vocabulary of tokens can include any of: characters, subwords, words, punctuation marks, sign tokens (e.g., the #, $, and other signs), mathematical symbols, and so on. The vocabulary of tokens can also include one or more special tokens that are appended to input text sequences that processed by the neural network, e.g., a start of sequence token, an end of sequence token, a designated “class” token, and so on.

During training, the language model neural network 120 can generate a respective output for each of multiple tokens in an input sequence in a single forward pass, i.e., in parallel, by processing a single “current sequence” 104 that represents the entire input text sequence.

After training, the language model neural network 120 can be used to auto-regressively generate a text sequence by, at each time step, processing the current text sequence 104 as of the time step and then updating the current text sequence 104 by selecting a token from the vocabulary using the output for the current text sequence and then appending the selected token to the end of the current text sequence 104.

The visual encoder neural network 112 is a neural network that has parameters (“visual encoder neural network parameters” or “visual encoder parameters”) and receives a visual input 102 and processes the visual input 102 in accordance with the parameters to generate an encoded representation 114 of the visual input 102.

Generally, the encoded representation 114 includes a respective embedding (also referred to as “updated token”) for each of multiple patches in the visual input 102, e.g., for each of multiple spatial patches (regions) of each of the images of the visual input 102 or, in some cases where the visual input 102 includes multiple images, each of multiple spatio-temporal patches (regions) of the visual input 102.

An “embedding” as used in this specification is a vector of numeric values, e.g., floating point values or other values, having a pre-determined dimensionality. The space of possible vectors having the pre-determined dimensionality is referred to as the “embedding space.”

The visual encoder neural network 112 can have any appropriate architecture that allows the neural network 112 to map an input visual input 102 to an encoded representation 114. For example, the visual encoder neural network 112 can be a convolutional neural network. As another example, the visual encoder neural network 112 can be a vision Transformer neural network that has one or more self-attention layers. As yet another example, the visual encoder neural network 112 can be a neural network that has a mix of both convolutional and self-attention layers.

The language model neural network 120 can have any appropriate architecture that allows the language model neural network 120 to map the tokens in the text sequence to a respective uni-modal representation 124 for each of the tokens and then map the uni-modal representations 124 to the output defining the next token 128.

In a particular example, the language model neural network 120 can have an attention-based architecture, e.g., the architecture of a decoder-only Transformer neural network.

In this example, the set of initial uni-modal neural network layers 122 can include a sequence of initial attention layers, where each initial attention layer is configured to receive as input a respective current representation of each of the text tokens in the current text sequence and to process the respective current representations to generate as output a respective updated representation of each of the text tokens in the current text sequence. For example, each initial attention layer can apply a causally masked self-attention mechanism over the respective current representations to generate the respective updated representations.

A self-attention mechanism over the respective current representations refers to an attention mechanism that computes queries, keys, and values from the respective current representations.

A causally masked self-attention mechanism over the respective current representations refers to an attention mechanism in which any given position in the current text sequence does not attend over, i.e., does not have a non-zero attention weight for, any positions after the given position in the current text sequence.

Each attention layer can optionally apply other operations to the representations as part of updating the representations, e.g., by making use of a position-wise feed-forward neural network, by applying layer normalization, by making use of residual connections, and so on.

In this example, the respective current representations that are received as input by the first initial attention layer in the sequence of initial attention layers are respective embeddings of each of the text tokens in the current text sequence, e.g., as generated by an embedding layer of the language model neural network 120 and the respective current representations that are received as input by each subsequent initial attention layer, i.e., each initial attention layer after the first initial attention layer in the sequence of initial attention, layers are respective updated representations of the text tokens in the current text sequence that are generated as output by a preceding initial attention layer in the sequence of initial attention layers.

Thus, the respective uni-modal representations of the text tokens in the current text sequence are the respective updated representations of the text tokens in the current text sequence that are generated as output by the last initial attention layer in the sequence of initial attention layers.

More specifically, when the language model neural network 120 has an attention-based architecture, the initial attention layers include multiple self-attention layers but do not include any cross-attention layers to ensure that the respective updated representations of the text tokens in the current text sequence are uni-modal representations that depend only on the current text sequence and not on the visual input.

Additionally, the set of subsequent neural network layers 126 includes a sequence of subsequent attention layers, with each subsequent attention layer being configured to receive as input a respective current representation of each of the text tokens in the current text sequence and to process the respective current representations to generate as output a respective updated representation of each of the text tokens in the current text sequence.

Thus, the respective current representations that are received as input by the first subsequent attention layer in the sequence of subsequent attention layers are the respective uni-modal representations of each of the text tokens in the current text sequence (generated by the initial attention layers) and the respective current representations that are received as input by each subsequent attention layer after the first subsequent attention layer in the sequence of subsequent attention layers are respective updated representations of the text tokens in the current text sequence that are generated as output by the preceding subsequent attention layer in the sequence of subsequent attention layers.

In this example, like the initial attention layers, the sequence of subsequent attention layers also includes one or more self-attention layers. That is, for one or more of the subsequent neural network layers, processing the respective current representations to generate as output a respective updated representation of each of the text tokens in the current text sequence includes applying a causally masked self-attention mechanism. Each of these attention layers can optionally apply other operations to the representations as part of updating the representations, e.g., by making use of a position-wise feed-forward neural network, by applying layer normalization, by making use of residual connections, and so on.

Unlike the initial layers, the sequence of subsequent attention layers also includes one or more cross-modal layers. Each cross-modal layer processes the respective current representations to generate as output a respective updated representation of each of the text tokens in the current text sequence by applying a cross-attention mechanism between an input derived from (generated from) the encoded representation of the visual input and the respective current representations of the text tokens in the current text sequence received as input by the cross-modal layer.

“Cross-attention” between the input derived from the encoded representation of the visual input and the respective current representations of the text tokens in the current text sequence received as input by the cross-modal layer refers to an attention mechanism that uses queries derived from the respective current representations of the text tokens in the current text sequence and keys and values derived from the input generated from the encoded representation of the visual input.

Specific examples of self-attention, cross-attention, and causally masked self-attention mechanisms that can be employed by the system are described in Vaswani et al. “Attention is all you need”, 31st Conference on Neural Information Processing Systems (NIPS 2017), Long Beach, CA, USA; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoory Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020, Hua, et al, Transformer Quality in Linear Time, arXiv preprint arXiv:2202.10447, 2022.

In some implementations, the input that is derived from the encoded representations (also referred to as a captioning representation below) are the embeddings in the encoded representation 114.

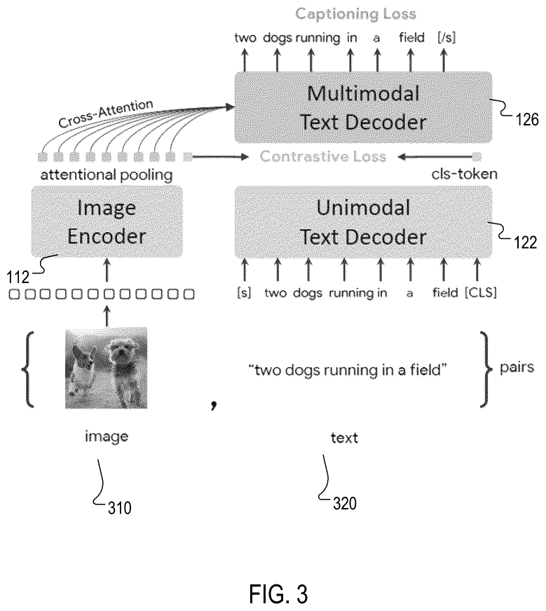

In some other implementations, the neural network 110 applies one or more transformations to the encoded representation 114 to generate the input that is provided to the cross-modal layers. One example of these transformations is described in more detail below with reference to FIG. 3.

Thus, the updated representations generated by a given cross-modal layer are multi-modal representations that depend on the visual input and on the text tokens in the current text sequence. Each of these cross-modal layers can optionally apply other operations to the representations as part of updating the representations, e.g., by making use of a position-wise feed-forward neural network, by applying layer normalization, by making use of residual connections, and so on.

As one example, the sequence of subsequent attention layers can alternate between self-attention layers and cross-modal layers. As another example, the sequence of subsequent attention layers can include a cross-modal layer after every two, three, or four self-attention layers.

Thus, due to the presence of the cross-modal layers, the representations generated by the last subsequent attention layer in the sequence are multi-modal representations, as described above.

To generate the score distribution, the set of subsequent neural network layers 126 can also include an output layer block.

The output layer block is a set of one or more neural network layers, e.g., one or more fully-connected layers followed by a softmax layer, that is configured to receive one or more of the respective updated representations of the text tokens in the current text sequence that are generated as output by the last subsequent attention layer in the sequence of subsequent attention layers and to process the one or more respective updated representations to generate the output defining the new token to be appended to the current text sequence, i.e., to generate the score distribution over the tokens in the vocabulary.

For example, during training, when the current output sequence is the entire training sequence, the output layer block can generate the respective score distributions for each of the text tokens in parallel by, for each text token, processing the updated representation of the token that immediately precedes the text token in the training sequence to generate the score distribution for the text token. In this example, the system can augment the training sequence with a designated start of sequence of token before processing the training sequence using the language model neural network.

After training, when the system 100 is operating auto-regressively, the output layer block can generate a single score distribution for current output sequence by processing the updated representation for the last token in the current output sequence. The system 100 can then select the next token to be added to the current output sequence using the score distribution generated by the output layer block. For example, the system 100 can select the token with the highest score in the score distribution or can sample a token from the score distribution.

Generally, the system 100 or another training system can pre-train the contrastive captioning neural network 110 on both a contrastive loss and a captioning loss.

The contrastive loss can depend on the encoded representations generated by the visual encoder 112 and the representations 124 generated by the initial neural network layers 122 while the captioning loss can depend on the encoded representations 124 generated by the visual encoder and the representations generated by subsequent neural network layers 126.

That is, because of the architecture of the neural network 110, the contrastive captioning neural network 110 can effectively be pre-trained by jointly using both a contrastive loss and a captioning loss without increasing the number of forward passes that need to be performed through the language model neural network 120 and the visual encoder neural network 112.

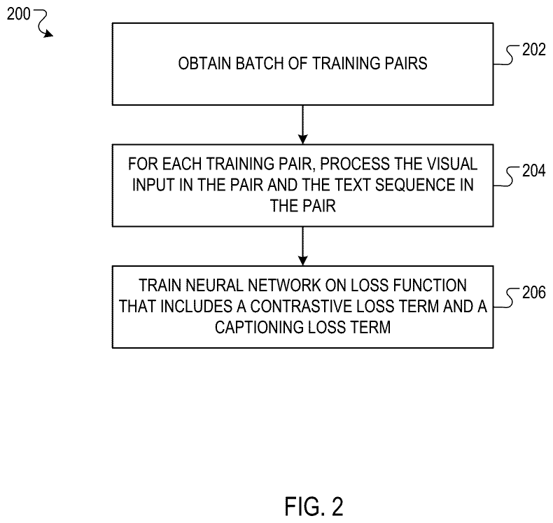

Pre-training the neural network 110 is described in more detail below with reference to FIGS. 2 and 3.

After the contrastive captioning neural network 110 has been pre-trained, the visual encoder 112, the initial layers 122, the subsequent layers 126 or some combination of the above can be used for a downstream task.

In some implementations, the downstream task can be performed in a zero shot manner, i.e., without further training of any of the components of the contrastive captioning neural network 110.

In some other implementations, the downstream task can be performed after fine-tuning one or more of the components of the contrastive captioning neural network 110 on labeled training data for the downstream task.

For example, the system 100 can hold the visual encoder 112 and any parts of the language model neural network 120 that are used for the downstream task fixed while learning a customized attentional pooling layer and, optionally, one or more additional output layers that receive the output of the attentional pooling layer, the output of one of the layers of the language model neural network 120, or both that are specific to the downstream task.

As another example, the system 100 can also fine-tune the visual encoder 112 and any parts of the language model neural network 120 that are used for the downstream task.

In some examples, the downstream task may be an image or video processing task.

In some examples, the downstream task is a visual classification task that requires classifying a visual input into one of a set of categories that each correspond to a different object type.

In some other examples, the downstream task is visual action recognition task that requires classifying a video input into one of a set of action categories.

In some examples, the downstream task is a cross-modal retrieval task that requires (i) retrieving one or more most similar text sequences to a visual input or (ii) retrieving one or more most similar visual inputs to a text sequence.

In some examples, the downstream task is a multimodal understanding task. For example, the task can be a visual question answering task (VQA) that requires generating an answer to a question that is posed about a visual input.

In some examples, the downstream task is an image captioning task that requires generating a text caption for a visual input.

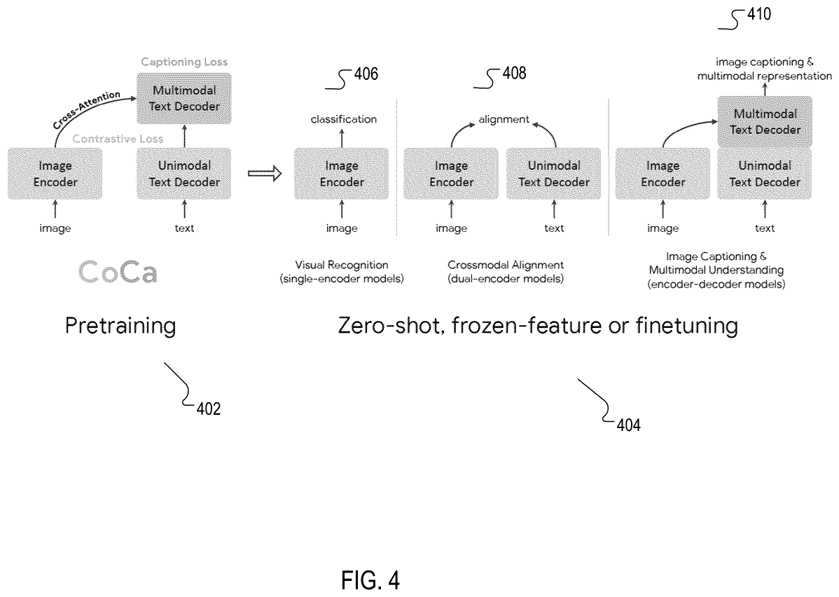

Downstream tasks are described in more detail below with reference to FIG. 4.

FIG. 2 is a flow diagram of an example process 200 for training the captioning neural network. For convenience, the process 200 will be described as being performed by a system of one or more computers located in one or more locations. For example, a neural network system, e.g., the neural network system 100 of FIG. 1, appropriately programmed, can perform the process 200.

The system can repeatedly perform iterations of the process 200 on different batches of training examples to update the parameters of the visual encoder neural network, the language model neural network, or both.

That is, at each iteration of the process 200, the system obtains a batch of training pairs, e.g., by sampling the batch from a larger set of training data, and uses the batch of one or more training pairs to update the parameters of the visual encoder neural network and the language model neural network.

The system can continue performing iterations of the process 200 until termination criteria for the training of the neural network have been satisfied, e.g., until the parameters have converged, until a threshold amount of wall clock time has elapsed, or until a threshold number of iterations of the process 200 have been performed.

The system obtains a batch of one or more training pairs (step 202).

Each training pair includes a visual input and an input text sequence.

In particular, the input text sequence has been determined by the system or an external source to describe the contents of the visual input or otherwise be relevant to the visual input. In other words, the visual input and the input text sequence have been determined to be semantically similar.

For example, within a given training pair, the text sequence can be a text annotation of the visual input from a set of manually or automatically generated image annotations or can be alt text associated with the visual input in a set of alt-text data. Alt text is text that is displayed in place of an image on a web page, e.g., if the image cannot be rendered properly or otherwise fails to load. For example, the system can obtain the alt-text data from data maintained by an Internet search engine or other software that automatically crawls web pages on the Internet.

For each training pair, the system processes the respective visual input and the respective text sequence in the training pair using the contrastive captioning neural network (step 204).

In particular, for each training pair, the system processes the visual input in the training pair using the visual encoder neural network to generate an encoded representation of the visual input.

The system processes the text sequence in the training pair using the set of initial neural network layers to generate a respective uni-modal representation of each of the text tokens in the text sequence. The representation is referred to as “uni-modal” because the representation depends only on the text tokens in the text sequence and not on the visual input.

The system processes the respective uni-modal representations of the text tokens in the text sequence using the set of subsequent neural network layers to generate, for each of a plurality of text tokens from the respective text sequence, a respective score distribution over the vocabulary of text tokens. As described above, the system can generate these score distributions for each of the plurality of text tokens in parallel.

For each training pair, processing the text sequence in the training pair using the set of initial neural network layers and processing the respective uni-modal representations using the set of subsequent neural network layers is performed in a single forward pass through the language modeling neural network. That is, the system only needs to perform a single forward pass through the language model neural network to generate both the uni-modal representations (that will be used to compute the contrastive loss) and the score distributions (that will be used to compute the captioning loss).

The system trains the neural network to minimize a loss function that includes (i) a contrastive learning loss term that is based on similarities between contrastive representations derived from the encoded representations of the visual inputs and uni-modal representations of one or more of the text tokens from each of the text sequences in the training pairs and (ii) a captioning loss term that is based on, for each training pair, the respective score distributions for the plurality of text tokens in the respective text sequence (step 206).

That is, the system can compute gradients of the loss function with respect to the parameters of the visual encoder neural network and the language model neural network, e.g., through backpropagation, and then apply an optimizer to the gradients to update the parameters of the visual encoder neural network and the language model neural network.

Because, as described above, the system only needs to perform a single forward pass through the language model neural network to generate both the uni-modal representations (that will be used to compute the contrastive loss) and the score distributions (that will be used to compute the captioning loss), the system can use different outputs of the same forward pass to compute the quantities required for each of the two losses.

Thus, even though the neural network is being trained on both the contrastive loss and the captioning loss, only a single forward pass through the visual encoder neural network and the language model neural network is required to evaluate both losses.

In more detail, the contrastive loss is based on a “contrastive representation” of each of the visual inputs in the batch and, for each text sequence in the batch, one or more of the uni-modal representations for one or more of the text sequences in the batch.

As a particular example, each text sequence in the batch can include the same designated token located at the same position within each text sequence. For example, the system or another system can augment each text sequence with a designated token, e.g., a “CLS” token placed at the end of every text sequence. The system can then use the uni-modal representation of the designated token to compute the contrastive loss.

Computing the contrastive representation is described in more detail below with reference to FIG. 3.

The goal of the contrastive loss is to train the visual encoder 112 and the language model 120 so that they can embed image and text inputs into the representation space, i.e., the space of the contrastive representations and the uni-modal representations, in such a way that inputs with similar semantics are mapped to nearby points regardless of their modalities.

Thus, the system can train the neural network 112 and the neural network 120 that encourages, for all training pairs in the batch that include a visual input xᵢ and a text sequence yᵢ, the embedding of xᵢ (i.e., the contrastive representation) and the embedding of yᵢ (the uni-modal representation for the designated token) to be closer together while being farther from all other embeddings of all other visual inputs and text segments in the batch.

A particular example of a contrastive loss 130 will be described next.

Based on the embeddings for the images and the text segments in the pairs in the mini-batch, an N×N similarity matrix A is computed, where A_{i;j} is a value that represents how similar the embedding of xᵢ is to the embedding of yᵢ. For example, A_{i;j} can be the dot product between the embedding of xᵢ and the embedding of yᵢ.

The system can then train the language model neural network and the visual encoder neural network using gradients of a contrastive loss computed using the matrix A. For example, the contrastive loss can be the cross-entropy loss on the rows and columns of A, where the diagonal entries are treated as correct classes while other entries are treated as incorrect classes. A specific example of such a loss is:

$${L}_{Con} = - \frac{1}{N} ( {\sum }_{i = 1}^{N} log ( \frac{{e}^{\frac{{A}_{i , i}}{σ}}}{{\sum }_{j} {e}^{\frac{{A}_{i , j}}{σ}}} ) + {\sum }_{j = 1}^{N} log ( \frac{{e}^{\frac{{A}_{j , j}}{σ}}}{{\sum }_{i} {e}^{\frac{{A}_{i , j}}{σ}}} ) ) ,$$

where σ is the softmax temperature that scales the logits, e.g., which serves to steepen or dampen the softmax distributions in the rows and columns of A, and N is the total number of training pairs in the batch. In some cases, prior to computing the matrix A, the system normalizes the contrastive representations and the uni-modal representations of the visual inputs and text sequences in the batch.

As this loss is minimized, for all pairs in the batch, the embeddings of xᵢ and yᵢ become closer together while becoming farther from all other embeddings of all other visual inputs and text segments in the batch, thereby achieving the goal of the contrastive learning.

The captioning loss term measures, for each training pair and for each of the plurality of tokens from the respective text sequence, a quality of the respective score distribution for the token relative to a corresponding token in the text sequence. As described above, because the score distributions are generated using the outputs of the subsequent attention layers of the language model neural network, the score distributions depend on both the visual input and the text sequence.

As a particular example, the captioning loss for a given training pair may be given by:

L_{Cap}=−Σₜ₌₁^{T} log P_{θ}(yₜ|y_{<t},x),

with the overall captioning loss being the average of the captioning losses for the training pairs in the batch, T being the total number of positions in the training text sequence in the training pair, and P_{θ}(yₜ|y_{<t},x) being the score assigned, in the score distribution that was generated conditioned on the tokens preceding the token at position t in the training text sequence and the visual input x in the training pair, to the token yₜ at the position t in the training text sequence.

The overall loss for the pre-training can be, e.g., a weighted sum of the captioning loss and the contrastive loss.

FIG. 3 is a diagram that shows an example of the training of the neural network 110 on the contrastive and captioning losses.

In particular, FIG. 3 shows an example of how the neural network 110 is trained on a training pair that includes an image 310 and a text sequence 320 “two dogs running in a field.”

As shown in FIG. 3, the system processes the image 310 using the visual encoder neural network 112 to generate an encoded representation of the image 310.

The system then generates, from the encoded representation, two representations: a contrastive representation that will be used for the contrastive loss, as described above, and a captioning representation that will be used to condition the cross-modal layers within the language model neural network 120 as described above, i.e., that is the input derived from the encoded representation.

The system can generate the contrastive representation in any of a variety of ways.

As one example, the system can use, as the contrastive representation, the embedding of a designated token within the encoded representation. That is, when dividing a given visual input into patches, the neural network 112 can add a placeholder patch that does not correspond to any of the patches in the visual input. The system can then use the embedding of this placeholder patch as the contrastive representation.

As another example, the system can use pooling to generate the contrastive representation. As one example, the system can apply a pooling operation, e.g., global average pooling (GAP), on the embeddings in the encoded representation and use the resulting pooled embedding as the contrastive representation.

As yet another example, the system can use learned attentional pooling to generate the contrastive representation. To perform learned attentional pooling, the system can incorporate an attentional pooling layer within the contrastive captioning neural network 110.

The attentional pooling layer applies attention over the updated tokens, i.e., the embeddings in the encoded representation, and a set of learned query tokens to generate a respective updated query token for each of the learned query tokens in the second set. That is, the system uses the learned query tokens to generate queries for the attention mechanism applied by the attentional pooling layer and the embeddings in the encoded representation to generate keys and values for the attention mechanism. The output of the attentional pooling layer is therefore an updated query token for each of the set of query tokens.

The set of learned query tokens and the parameters of the attention mechanism are learned jointly with the parameters of the language model neural network and the visual encoder neural network during the pre-training.

To generate the contrastive representation, the system can use a set of learned query tokens that has only a single query token, and can use the updated query token for the single query token as the contrastive representation.

The system can generate the captioning representation in any of a variety of ways.

As one example, the system can directly use the encoded representation as the captioning representation.

As another example, the system can incorporate another attentional pooling layer for which the set of learned query vectors has multiple query vectors and then use the updated query tokens generated by the attentional pooling layer as the encoded representation.

When used, the attentional pooling layers can serve as “task adaptors” that (i) ensure that the captioning task receives a more fine-grained input that separately represents different regions within the visual input while the contrastive task receives a global representation that represents the entire visual input and (ii) allow the outputs of the visual encoder to be adapted in a learned manner differently for each of the tasks, improving the quality of the pre-training in many situations.

The system then processes the text sequence 320 using the language model neural network 120 as described above. In particular, the language model neural network 120 first generates uni-modal representations by processing the text sequence 320 using the initial layers 122 (“unimodal text decoder”) and then processes those uni-modal representations conditioned through cross-attention on the captioning representation using the subsequent layers 126 (“multimodal text decoder”) to generate the outputs that define the tokens in the text sequence 320.

In the example of FIG. 3, the system then computes the contrastive loss using the uni-modal representation for the “[CLS]” token and the contrastive representation generated using attentional pooling while computing the captioning loss using the outputs for the tokens in the text sequence 320 as described above.

FIG. 4 shows how the contrastive captioning neural network 110 can be used for various downstream tasks.

As shown in FIG. 4, the system first performs pretraining 402 of the “CoCa” neural network 110 as described above.

The system can then perform zero-shot, frozen-feature, or finetuning downstream adaptation 404 in order to use at least part of the CoCa neural network 110 for a downstream task.

That is, in some implementations, the neural network 110 can be adapted to the downstream task in a zero shot manner, i.e., without further training of any of the components of the contrastive captioning neural network 110 or any additional components.

In some other implementations, the downstream task can be performed after fine-tuning one or more of the components of the contrastive captioning neural network 110 on labeled training data for the downstream task, e.g., through supervised learning.

For example, for frozen-feature adaptation, the system can hold the visual encoder 112 and any parts of the language model neural network 120 that are used for the downstream task fixed while learning a customized attentional pooling layer for the task and, optionally, one or more additional output layers that receive the output of the attentional pooling layer, the output of one of the layers of the language model neural network 120, or both that are specific to the downstream task.

As another example, for fine-tuning adaptation, the system can also fine-tune the visual encoder 112 and any parts of the language model neural network 120 that are used for the downstream task.

In some examples, the downstream task is a visual classification task 406 that requires classifying a visual input into one of a set of categories that each correspond to a different object type. In this example, the system can use at least the visual encoder 112 and then process the encoded representation generated by the visual encoder 112 to generate the classification.

For example, the system can perform zero-shot visual classification by processing text labels for the set of categories using the language model neural network to generate a uni-modal representation for each category and processing the visual input using the visual encoder 112 to generate a contrastive representation for the visual input. The system can then select the category having the uni-modal representation that is most similar to the contrastive representation as a classification for the visual input.

In some other examples, the downstream task is visual action recognition task that requires classifying a video input into one of a set of action categories.

In these examples, the system can use only the visual encoder 112 and can learn a customized attention pooling layer and one or more output layers for the visual action recognition task. As a particular example, the system can take multiple frames of a video and feed each frame into the shared visual encoder individually. For frozen feature evaluation or finetuning, the system can learn an additional pooler on top of the spatial and temporal feature tokens with a softmax cross-entropy loss. Note the pooler has a single query token thus the computation of pooling over all spatial and temporal tokens is not expensive.

In some examples, the downstream task is a cross-modal alignment task 408 that requires (i) retrieving one or more most similar text sequences to a visual input or (ii) retrieving one or more most similar visual inputs to a text sequence. In these examples, the system can use the visual encoder neural network 112 and the initial layers of the language model neural network (the unimodal text decoder). For example, for zero-shot video-text retrieval, the system can use a simple approach in which the system computes the mean embedding of a set of frames of the video (frames are uniformly sampled from a video) and uses the mean embedding as the representation of the video.

In some examples, the downstream task is a multimodal understanding task 410. In these examples, the system can use the entire language model neural network 120 (both the unimodal decoder and the multimodal decoder) and the visual encoder 112.

For example, the task can be a visual question answering task (VQA) that requires generating an answer to a question that is posed about a visual input.

As another example, the downstream task is an image captioning task that requires generating a text caption for a visual input.

Thus, after performing downstream adaptation 404, the system can receive a new input for a downstream task and process the new input using a downstream task neural network to generate a task output for the downstream task. Depending on the downstream task, the downstream task neural network can include one or more of (i) a visual encoder, (ii) an initial set of neural network layers, or (iii) a subsequent set of neural network layers to generate a task output for the downstream task.

Table 1 shows examples of the performance of CoCa on two downstream tasks—image classification (left) and video action recognition (right)—relative to existing techniques. Table 1 shows the performance of downstream adaptation using a frozen technique in which the components of CoCa are not further trained and a fine-tuning technique where the components of CoCa are fine-tuned.

TABLE 1

| Model | ImageNet | Model | K-400 | K-600 | K-700 | Moments-in-Time |
|---|---|---|---|---|---|---|
| ALIGN [13] | 88.6 | ViViT [53] | 84.8 | 84.3 | — | 38.0 |
| Florence [14] | 90.1 | MoViNet [54] | 81.5 | 84.8 | 79.4 | 40.2 |
| MetaPseudoLabels [51] | 90.2 | VATT [55] | 82.1 | 83.6 | — | 41.1 |
| CoAtNet [10] | 90.9 | Florence [14] | 86.8 | 88.0 | — | — |
| ViT-G [21] | 90.5 | MaskFeat [56] | 87.0 | 88.3 | 80.4 | |
| +Model Soups [52] | 90.9 | CoVeR [11] | 87.2 | 87.9 | 78.5 | 46.1 |
| CoCa (frozen) | 90.6 | CoCa (frozen) | 88.0 | 88.5 | 81.1 | 47.4 |
| CoCa (finetuned) | 91.0 | CoCa (finetuned) | 88.9 | 89.4 | 82.7 | 49.0 |

As can be seen from Table 1, the described techniques are competitive with existing techniques with zero fine-tuning and outperform existing techniques on both tasks with fine-tuning.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system comprising one or more computers and one or more storage devices storing instructions that when executed by the one or more computers cause the one or more computers to implement a contrastive captioning neural network, the neural network comprising:
a visual encoder neural network that is configured to process a visual input that includes one or more images to generate an encoded representation of the visual input; and
a language model neural network, wherein the language model neural network is configured to process a current text sequence to generate an output defining a new token to be appended to the current text sequence, wherein the current text sequence comprises a respective text token at each of one or more input positions, and wherein the language model neural network comprises:
a set of initial neural network layers that are configured to process an input comprising each text token in the current text sequence to generate a respective uni-modal representation of each of the text tokens in the current text sequence that is independent of the visual input; and
a set of subsequent neural network layers that are configured to process an input comprising the respective uni-modal representations of the text tokens in the current text sequence to generate the output defining the new token to be appended to the current text sequence, wherein the subsequent neural network layers comprise one or more cross-modal layers that are conditioned on the encoded representation of the visual input.

2. The system of claim 1, wherein:
the set of initial uni-modal neural network layers comprises a sequence of initial attention layers,
each initial attention layer is configured to receive as input a respective current representation of each of the text tokens in the current text sequence and to process the respective current representations to generate as output a respective updated representation of each of the text tokens in the current text sequence,
the respective current representations that are received as input by a first initial attention layer in the sequence of initial attention layers are respective embeddings of each of the text tokens in the current text sequence, and
the respective current representations that are received as input by each initial attention layer after the first initial attention layer in the sequence of initial attention layers are respective updated representations of the text tokens in the current text sequence that are generated as output by a preceding initial attention layer in the sequence of initial attention layers.

3. The system of claim 2, wherein the respective uni-modal representations of the text tokens in the current text sequence are the respective updated representations of the text tokens in the current text sequence that are generated as output by a last initial attention layer in the sequence of initial attention layers.

4. The system of claim 2, wherein processing the respective current representations to generate as output a respective updated representation of each of the text tokens in the current text sequence comprises applying a causally masked self-attention mechanism.

5. The system of claim 1, wherein the output defining the new token to be appended to the current text sequence comprises a score distribution that assigns a respective score to each text token in a vocabulary of text tokens.

6. The system of claim 1, wherein:
the set of subsequent neural network layers comprises a sequence of subsequent attention layers,
each subsequent attention layer is configured to receive as input a respective current representation of each of the text tokens in the current text sequence and to process the respective current representations to generate as output a respective updated representation of each of the text tokens in the current text sequence,
the respective current representations that are received as input by a first subsequent attention layer in the sequence of subsequent attention layers are the respective uni-modal representations of each of the text tokens in the current text sequence, and
the respective current representations that are received as input by each subsequent attention layer after the first subsequent attention layer in the sequence of subsequent attention layers are respective updated representations of the text tokens in the current text sequence that are generated as output by a preceding subsequent attention layer in the sequence of subsequent attention layers.

7. The system of claim 6, wherein the set of subsequent neural network layers further comprises:
an output layer block that is configured to receive one or more of the respective updated representations of the text tokens in the current text sequence that are generated as output by a last initial subsequent attention layer in the sequence of subsequent attention layers and to process the one or more respective updated representations to generate the output defining the new token to be appended to the current text sequence.

8. The system of claim 6, wherein, for one or more of the subsequent neural network layers, processing the respective current representations to generate as output a respective updated representation of each of the text tokens in the current text sequence comprises applying a causally masked self-attention mechanism.

9. The system of claim 6, wherein the one or more cross-modal layers are each a respective one of the subsequent attention layers in the sequence of subsequent attention layers, and wherein, for each cross-modal layer, processing the respective current representations to generate as output a respective updated representation of each of the text tokens in the current text sequence comprises applying a cross-attention mechanism between an input derived from the encoded representation of the visual input and the respective current representations of the text tokens in the current text sequence received as input by the cross-modal layer.

10. The system of claim 1, wherein the encoded representation comprises a respective updated token for each of a plurality of patches of the visual input.

11. The system of claim 10, wherein the contrastive captioning neural network further comprises:
a first attentional pooling layer that applies attention over the updated tokens and a first set of learned query tokens to generate a respective updated query token for each of the learned query tokens, and wherein each cross-modal layer receives as input the respective updated query tokens.

12. The system of claim 11, wherein the one or more cross-modal layers are each a respective subsequent attention layer that is configured to apply a cross-attention mechanism between an input derived from the encoded representation of the visual input and respective current representations of the text tokens in the current text sequence received as input by the cross-modal layer, and wherein the input derived from the encoded representations is the respective updated query tokens.

13. The system of claim 10, wherein the visual encoder neural network is a vision Transformer neural network.

14. The system of claim 10, wherein the contrastive captioning neural network further comprises:
a second attentional pooling layer that applies attention over the updated tokens and a second set of learned query tokens to generate a respective updated query token for each of the learned query tokens in the second set.

15. The system of claim 14, wherein the second set of learned query tokens includes only a single learned query token.

16. A method of training a contrastive captioning neural network that comprises (i) a visual encoder neural network, (ii) an initial set of neural network layers, an (iii) a subsequent set of neural network layers, the method comprising:
obtaining a set of one or more training pairs that each include a respective visual input and a respective text sequence;
for each training pair, processing the respective visual input and the respective text sequence in the training pair using the contrastive captioning neural network, comprising:
processing the visual input in the training pair using the visual encoder neural network to generate an encoded representation of the visual input;
processing the text sequence in the training pair using the set of initial neural network layers to generate a respective uni-modal representation of each of the text tokens in the text sequence; and
processing the respective uni-modal representations of the text tokens in the text sequence using the set of subsequent neural network layers to generate, for each of a plurality of text tokens from the respective text sequence, a respective score distribution over the vocabulary of text tokens; and
training the neural network to minimize a loss function that includes (i) a contrastive learning loss term that is based on similarities between contrastive representations derived from the encoded representations of the visual inputs and uni-modal representations of one or more of the text tokens from each of the text sequences in the training pairs and (ii) a captioning loss term that is based on, for each training pair, the respective score distributions for the plurality of text tokens in the respective text sequence.

17. The method of claim 16, wherein, for each training pair, processing the text sequence in the training pair using the set of initial neural network layers and processing the respective uni-modal representations using the set of subsequent neural network layers is performed in a single forward pass through the language model neural network.

18. The method of claim 16, wherein the captioning loss term measures, for each training pair and for each of the plurality of tokens from the respective text sequence, a quality of the respective score distribution for the token relative to a corresponding token in the text sequence.

19. The method of claim 16, wherein each training text sequence in each training pair includes a same designated token, and wherein the contrastive learning loss term is based on similarities between the contrastive representations derived from the encoded representations for the visual inputs in the training pairs and the respective uni-modal representations for the designated tokens in the training text sequences in the training pairs.

20. The method of claim 16, wherein the encoded representation comprises a respective updated token for each of a plurality of patches of the visual input, wherein the contrastive captioning neural network further comprises: a second attentional pooling layer that applies attention over the updated tokens and a second set of learned query tokens to generate a respective updated query token for each of the learned query tokens in the second set, wherein the second set of learned query tokens includes only a single learned query token, wherein the contrastive representation for each visual input is the updated query token for the single query token in the second set.

21. The method of claim 16, wherein the encoded representation comprises a respective updated token for each of a plurality of patches of the visual input, wherein the contrastive representation for each visual input is generated by pooling the respective updated tokens for each of the plurality of patches of the visual input.

22. The method of claim 16, further comprising:
after the training, using one or more of (i) the visual encoder, (ii) the initial set of neural network layers, or (iii) the subsequent set of neural network layers to perform a downstream task.

23. The method of claim 22, further comprising:
after the training and prior to using one or more of (i) the visual encoder, (ii) the initial set of neural network layers, or (iii) the subsequent set of neural network layers to perform a downstream task, fine-tuning one or more components of the contrastive captioning neural network on labeled training data for the downstream task.

24. The method of claim 22, further comprising: after the training and prior to using one or more of (i) the visual encoder, (ii) the initial set of neural network layers, or (iii) the subsequent set of neural network layers to perform a downstream task, fine-tuning a downstream neural network that includes the one or more components of the contrastive captioning neural network on labeled training data for the downstream task.

25. The method of claim 24, wherein fine-tuning the downstream neural network comprises training one or more additional components of the downstream neural network while holding the one or more of more of (i) the visual encoder, (ii) the initial set of neural network layers, or (iii) the subsequent set of neural network layers fixed.

26. A method performed by one or more computers, the method comprising:
receiving a new input for a downstream task; and
processing the new input using a downstream task neural network to generate a task output for the downstream task, wherein downstream task neural network comprises one or more of (i) a visual encoder, (ii) an initial set of neural network layers, or (iii) a subsequent set of neural network layers to generate a task output for the downstream task, wherein the (i) the visual encoder, (ii) the initial set of neural network layers, or (iii) the subsequent set of neural network layers have been trained as part of a contrastive captioning neural network, the training comprising:
obtaining a set of one or more training pairs that each include a respective visual input and a respective text sequence;
for each training pair, processing the respective visual input and the respective text sequence in the training pair using the contrastive captioning neural network, comprising:
processing the visual input in the training pair using the visual encoder neural network to generate an encoded representation of the visual input;
processing the text sequence in the training pair using the set of initial neural network layers to generate a respective uni-modal representation of each of the text tokens in the text sequence; and
processing the respective uni-modal representations of the text tokens in the text sequence using the set of subsequent neural network layers to generate, for each of a plurality of text tokens from the respective text sequence, a respective score distribution over the vocabulary of text tokens; and
training the contrastive captioning neural network to minimize a loss function that includes (i) a contrastive learning loss term that is based on similarities between contrastive representations derived from the encoded representations of the visual inputs and uni-modal representations of one or more of the text tokens from each of the text sequences in the training pairs and (ii) a captioning loss term that is based on, for each training pair, the respective score distributions for the plurality of text tokens in the respective text sequence.
